(19) United States
(12) Patent Application Publication
(10) Pub. No.: US 2021/0337921 A1
(43) Pub. Date: Nov. 4, 2021

(54) TRUE SHOCKS

(71) Applicant: Ricardo Anthony Mcbean, West Park, FL (US)

(72) Inventor: Ricardo Anthony Mcbean, West Park, FL (US)

(21) Appl. No.: 16/863,938

(22) Filed: Apr. 30, 2020

(51) Int. Cl. A43B 7/32; H02J 7/00; H02N 2/18; A43B 3/00; A43B 1/10; A43B 5/06

(52) U.S. Cl. CPC A43B 7/32; H02J 7/0042; A43B 5/06; A43B 3/0015; A43B 1/10; H02N 2/186

(57) ABSTRACT

The present invention is a type of shock absorbent shoes with the heel portion of each shoe bottom divided into an upper and lower portion; by having a horizontal gap between the outsole and midsole or along the midsole. Also, several resistive devices are each connected to said lower portion and said upper portion or the upper of said shoe. Whereby, having resistive device attached to the side of both the outsole and midsole and/or upper; allow them to be more lengthy, hence more energy can be store and released along, their entire length, to the point where both the outsole and midsole touches, therefore, the amount of play the resistive devices have is dependent on the amount of space between said outsole and midsole. Each shoe also includes a small detachable power bank charger device for use of partially charging of cell phone, blue tooth speakers, wireless ear buds etc. Each power bank is charged by electrical pulse from a piezoelectric device via a circuit board and is fitted to a modest structure on the shoe such that it does not cause the shoes to look bulky or feel uncomfortable.

### FIELD OF INVENTION

The present invention relates to shock absorbing shoes, specifically it, maximizes the process of absorbing shock and returning it as energy for a push forward.

### BACKGROUND OF INVENTION

Sneakers with some form of shock absorbent technology is almost standard these days, whether the heel is made of a shock absorbent material or has a shock absorbent device attached. These shock absorbent shoes each works to a certain, but limited, extent, and only has shock absorbent capabilities only, but are nevertheless falsely advertised or implied to be energy return shoes. These energy return claims has little to no truth to it, as the prior arts in this field, all have the same intuitive design approach of putting the resistive device or material, either within the midsole or directly beneath the shoe. And while some shoes designed with these approach work better than others, they all have a basic inherit draw backs, as being under or within the bottom of the shoe, the resistive device, has limited flexibility and when under pressure can only be compressed so much before folding in on itself. Therefore, the process of absorbing shock and storing it as energy is limited to the amount of play the resistive device has under pressure. Furthermore, for energy to be returned to help push the feet off the ground; it should be transferred directly to the midsole and/or upper and not to surrounding material. In the present invention there is a significant gap separating the outsole and the midsole at the heel portion, where there are several resistive devices, each attached to the sides of both outsole and midsole or upper of the shoe. Therefore, these resistive devices have more length and play to store and release more energy, moreover, energy is released directly to the midsole and/or upper of the shoe for an extra push off the ground.

The Main features of the present invention are advanced shock absorbent and energy return capabilities, however, due to the significant amount of play allowing the resistive devices to repeatedly fold at a sharper angle; a significant volume of electrical pulses is harness by means attaching a piezoelectric devices directly to some of the resistive devices. This combination will generate a higher than average amount of electrical potential than the technology of the prior arts using similar piezoelectric devices. Therefore, the shock absorbent/energy return system of this shoes; when also has a built-in electrical component will, if not eliminate, significantly reduce the need for charging by an external source, some of these said electrical component are seen in self-lacing shoes and shoes with sensational lighting systems. However, in the present invention the specific electrical component is a power bank charger system, whereby said electrical pulses are used to charge a small detachable power bank charger device for later use of a partial or top up charging of a cell phone, blue tooth speakers, wireless ear buds etc.

### SUMMARY

The present invention is a type of shock absorbent and energy return shoes having a horizontal gap between the outsole and midsole, and a number of resistive devices connected to sides of both outsole and midsole or the upper of the shoes, resulting in a lengthier set of resistive devices that can store and release more energy along its entire length up to the point where the outsole touches the midsole. A piezoelectric device which is attached to a few of the resistive devices; generates electrical pulses that charges a small power bank charger device, which is carried on the shoe for easy access for use of pep up charging of on person devices such as phones and smart watches.

### BRIEF DESCRIPTIONS OF DRAWINGS

FIG. 1 shows a side view of the shoe with the detachable power bank in place.

FIG. 2 shows a side view of the shoe with the detachable power bank removed.

FIG. 3 shows a back view of the shoe.

FIG. 4 shows a side view and plan view of the resistive devices at the back of the shoe.

FIG. 5 shows a cut away cross-sectional side of the structure that holds the power bank, with the power bank in place.

FIG. 6 shows a cut away cross-sectional top view of the structure that holds the power bank, with the power bank in place.

FIG. 7 shows a plan view of the power bank.

FIG. 8 shows a cross-sectional end view of the power bank.

### DETAILED DESCRIPTION OF DRAWINGS

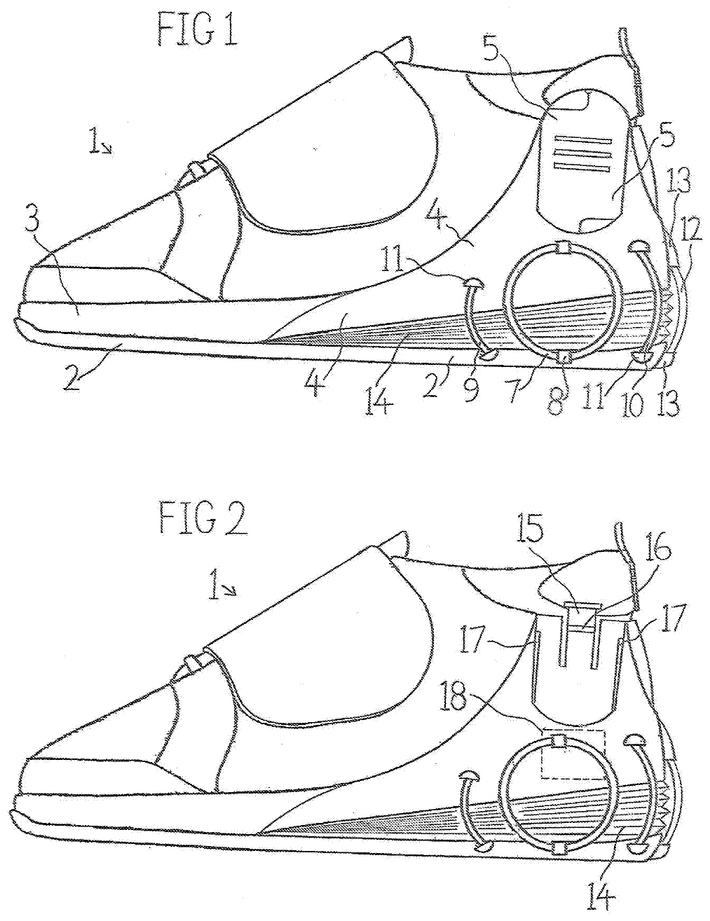

FIG. 1 side view and FIG. 3 back view both show the shoe 1 having an outsole 2 made of a flexible rubber, a two piece midsole; with the front portion 3 made of a type of foam, and the instep to the heel portion 4 made of a type of ridged rubber with a portion extending upwards along one side of the upper where there is a detachable power bank charger device 5, at the top close to the shoe opening. The heel portion 4 of the midsole is raised about a 25 degrees angle above the outsole 2 creating a space between them, this space is covered by a length of fabric 14 that has an accordion style design, and is attached along both sides of its length to the edges both the midsole 4 and the outsole 2. Extending between both said midsole 4 and outsole 2 are rubber type resistive devices, three on each side and two at the back. Seen at the center is a circular shape resistive device 7 that extends through a small ring shape raisings 8 on the side of both the midsole 4 and outsole 2, on opposite side of the circular resistive device 7, are bow shape resistive devices 9 and 10, both having each end fixed into a small cup shape raisings 11 on the side of both the midsole 4 and outsole 2. The two resistive devices 12 at the back are elongated rectangular shape, each fixed into two small but wider raisings 13, of the midsole and 4 outsole 2.

FIG. 2 shows the shoe 1 now without the power bank charger 5, it further shows the back wall of said extended portion of the midsole 4; having a clip 15 mechanism for locking the power bank 5 in place, the clip 15 is a strip separated from the rest of the structure by a slot on each side, it also has a strait horizontal raising 16 at the top. On opposite sides within the cavity that holds the power bank 5; is a vertically standing metallic/conductive straight edge 17, about halfway from the back wall, these metallic straight edges are wired to a circuit board 18 embedded within the lower part of the midsole 4 structure

FIG. 4 both show exploded views of the resistive devices 12 at the back of the shoe 1, the left figure shows a cross sectional side view of the resistive devices 12 and how each is made by laminating two strips with a piezoelectric device 19 between them, and the right shows a cross sectional plan view of the resistive device 12 with the piezoelectrical device 19 being well inbound for both said strips to be laminated to it and each other. Both piezoelectric devices are also wired to the circuit board 18.

Both said set of metallic straight edges 17 and piezoelectric devices 19 are wired to the circuit board 18; such that the electrical pulses generated by said piezoelectric 19 is transferred via said metallic edges 17, and stored in a battery 20 of said power bank 5.

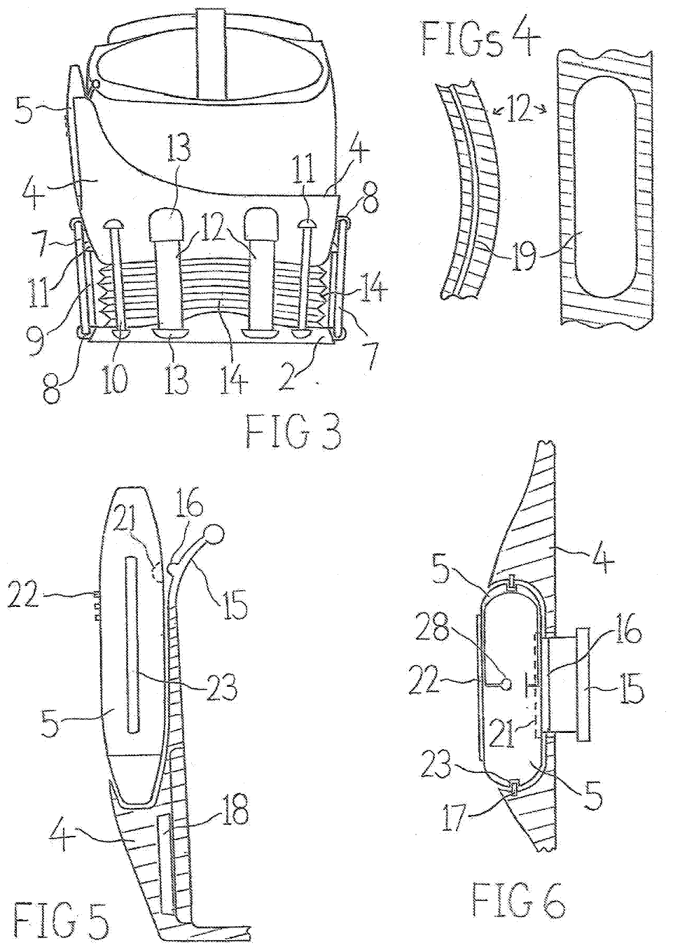

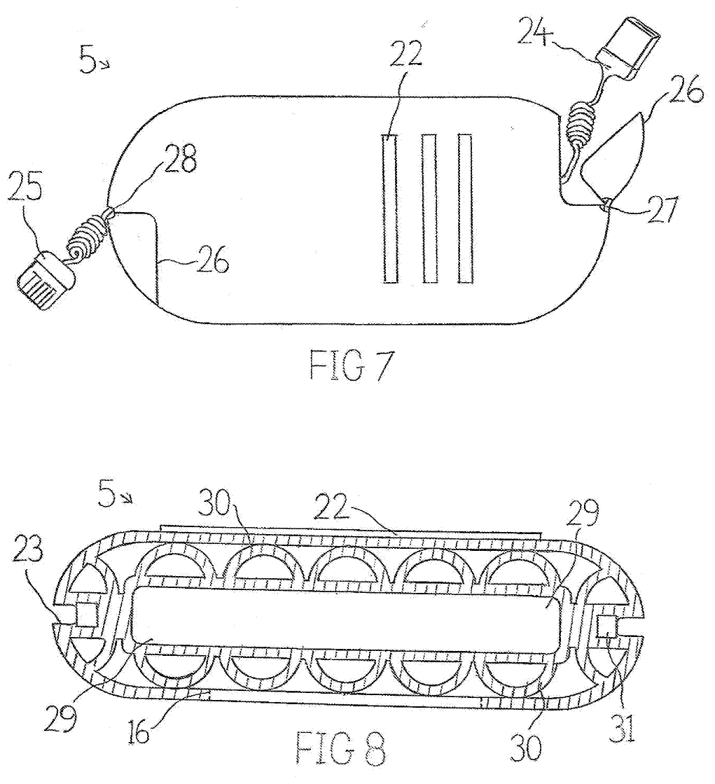

FIG. 5 side view and FIG. 6 plan view; both shows broken away cross sectional views of the power bank 5 withing said upward extended portion of the insole 4, they further show a slot 21 for receiving said horizontal raising 16, to lock the power bank 5 in place, in both figs the clip mechanism 15 is at a forced backwards position such that the power bank 5 is unlocked and can be removed. On the outer side of said power bank 5 are three raised straight edges 22(seen dearer in FIG. 7) for use of gripping the device when removing it from said upper structure of midsole 4. FIG. 5 again shows the position of the circuit board 18, it also shows a groove 23 along the side of the power bank 5, while FIG. 6 shows that said groove 23 is for receiving said metallic straight edge 17.

FIG. 7 shows a plan view of the power bank 5, it shows the rounded end portions which are hallow and each contains a cable, one has a micro USB tip 24 for android phones and the other a lightening tip 25 for IOS phones. The cables 24 and 25 both have a retractable coil design, and can each be access at one end through a cap 26, which is a half of the rounded end portion and is hinged 27 at the top where there is a small hole 28 to lead in said cable so the cap 26 can be snapped closed while the cables hangs outside.

FIG. 8 show a cross sectional end view of the power bank 5, it shows that the rechargeable battery 29 itself is embedded withing a network of arch structure 30 designed to distribute shock waves and protect said battery 29. Exposed within each groove 23, along its length, is a conductive metallic component 31, for use of grounding with said metallic straight edge 17 to transfer electrical pulsed to said battery 29; charging it. It also again shows the position of the slot for said clip/locking mechanism 15.

### Functions

The resistive devices 7 being on the sides of each shoe 1, allows them to be of a significant more height than those of other shoes, hence storing and releasing more energy along its entire length up to the point, where the midsole 4 touches the outsole 2; this amount of play is significantly more than that of traditional anti-shock shoes with their resistive devices directly beneath the midsole, causing them to fold in on themselves and is only compressed to a small degree. While jogging or running, each time the heel hits the ground; the energy from impact is transferred via the outsole 2, to the resistive devices 7, which dampens the impact by storing this energy along their lengths, this energy is the then simultaneously released while the foot leaves the ground and is mostly returned to the upper of the shoe 1, hence helping to lift the foot off the ground.

The process of storing and releasing energy is also simultaneously carried out by the piezoelectric device 19, the circuit board 18 and the power bank 5; whereby the piezoelectric 19 generates and send electrical pulses to the circuit board 18 which regulates and send electricity to the battery 20 of said power bank 5. The amount and frequency of the electrical pulses is stored as data on the circuit board 18 and is processed along with information entered via app such as weight, height along with GPS location; to produce and display useful information, such as speed, distance, time, calories lost, battery status etc.

### Further Advantages

The resistive devices of the prior art are relatively short at about an average height of ¾ inch and being directly beneath the bottom of the shoe; this mean they have to be of a certain firmness for a person to comfortably stand still without sinking at the heels, hence, they can only be compressed a small fraction. In contrast the present invention having a horizontal gap between the outsole and midsole, and a number of resistive devices connected to sides of both outsole and midsole or the upper of the shoes; results in a lengthier set of resistive devices that can store and release more energy along its entire length up to the point where the outsole touches the midsole, therefor, if said gap ¾ inch, then the heel can be compressed to that same length under maximum pressure. This is because together a set of resistant device can be firm, such that while under the pressure of an average to slightly overweight person standing still; they do not or is slightly bent out of shape, but at the same time is of a certain length and molded in a type of curved form that when varying degrees of pressure is applied by walking, running or jumping; they easily further bend and store energy, then return to original shape by releasing it. Therefore, the resistive devices of the prior arts being beneath the shoe, of a limited height, and having a standard firmness, hence, can only be compressed to a fraction of its height; is at a significant disadvantage when compared to the resistive devices of the present invention, as they are lengthier, designed and arranged to maintain their firmness, while capable of being compressed up to the entire height of most prior art's resistive devices.

Again, the detachable power bank charger device is small, such that it is fitted on a modest structure which does not cause the shoes to look odd and bulky or feel uncomfortable, but rather a comfortable pair of shoes with an ultra-effective shock absorber technology with the added feature of a power bank for pep up charging of small devices. This pep up power bank is by far a more necessary feature to have on a pair of shoes, rather than self-lacing, sensational lighting or massage features; as it is more common for your on person devices, such as cellphones, ear buds or smart watch; to run out of charge, hence, having a pep up power bank on each shoe would serve well for a number of devices, wherein anywhere from 25%-50% back up charging capability would be acceptable.

The present invention can have several alternative embodiments, such as; a version wherein the power bank charger could be hooked up to a short USB charger cable to receive charge while both it and said cable is placed in a pouch built on the side of the shoes, also, the resistive device could be in one continuous piece with a design which collapses accordion style such as a diamond style mesh like structure, or another version wherein there are several resistive devices, each being a spring hidden within an extendable pole like structure. However, the present particular design of the resistive device being circular or wheel shape next to a ridged structure give a psychology of a motor vehicle, hence, subconsciously suggest “Go Power”, this along with the other resistive devices being bow shaped, causes the mind to recognized and related to the technology and its ability to store and release energy. Therefore, this specific design is not only physically practical but also has some psychological function to give the consumer level of confidence to get and wear these shoes.

1. I claim a type of shock absorbent/energy return shoes with a power bank charger system, which includes;
a. At least the heel portion of each shoe bottom is separated into a lower an upper portion, causing a gap between them, said separation is preferably between the midsole and outsole.
b. A strip of material, preferably a type of fabric, connected along the edges or sides of both said midsole and outsole, such that said gap between them is closed off from object entering.
c. At least one resistive device having one end or portion attached to the side of said midsole and/or the upper of said shoe, and another end or portion, forms into, or attached to the side of said outsole, and preferably molded or attached in a form that protrudes outwards or to the side.
d. A means to generate electricity whenever the shoe hits the ground; by means of a device preferably attached directly said resistive device,
e. A power bank charger device, preferably small, for receiving and storing said electricity, said power bank includes a rechargeable battery along with one or more USB cables enclosed in a flexible but ridged casing that can be attached and detached to and from said shoe.
f. Extending along the heel portion of the instep and at least halfway the upper of said shoe; is ridged but flexible structure having a cavity and a clip mechanism to receive and lock/unlock said power bank, said flexible structure is preferably, connected to, or an extension of said midsole.
g. Said power bank is of such a design that when fitted and locked into said rigid structure; they form a structure which appears continuous, relatively flat, and gradually tappers off along the edges.
h. a circuit board/electronics encased in said rigid structure having wiring to both receive said generated electricity and send to said battery.
i. Wi-Fi/Bluetooth capability to send information from said circuit board to a smart phone app.
Whereby, having a resistive device attached to the side of both said outsole and midsole and/or upper; allows it to be more lengthy, hence more energy can be store and released along its entire length, up to the point where both said outsole and midsole comes into contact, and
Whereby, having a small power bank device will allow for quicker charging, and requires small structure to fit it onto said shoe.

2. In claim 1 wherein said resistive device is made of a type of rubber and amounts to eight on each shoe. Each side of said shoe has three resistive devices; one having a circular shape structure and the other two each having a bow shape structure and are on opposite sides of said circular structure. The remaining two said resistive devices are rectangular shaped structure attached vertically at the back of said shoe and are each made of two strips of said rubber laminated together. Each said resistive device is fixed at the top and bottom to said midsole and outsole by extending into or through a small knob raising.

3. In claim one wherein said fabric strip of material collapses and extends accordion style and is outside said space between said midsole and outsole.

4. In claim one wherein said a means to generate electricity is a piezoelectric device embedded between both said rubber strips as described in claim 2 and is wired to said circuit board.

5. In claim 1 wherein said power bank device casing also has; three horizontally raised lines on one side and a horizontal slot on the opposite side, two strip of conductive metal, one on each side within a groove along the length of the edge, each said metal strip is wired directly to said battery itself. Both ends of said casing is hallow and has a rounded structure; half of which is a cap with snap on/off mechanism and is hinged at the top where there is a small hole for said cable. Said USB cables amounts to two, each having an extendable ring coil design and is connected to said battery at one end where it is housed in said hollow portion, one of said cable has a mail tip for IOS phones and the other for Android phones.

6. In claim 1 wherein said ridged structure is a continuation of said midsole, it extends up to the shoe opening and is wider at the base and gradually gets narrower at the top; where said cavity for said power bank device is. Said clip mechanism of said cavity, is a strip which is part of the back wall portion; separated by having slots on both sides, and is curved backwards at the top, just before said curve is a horizontal raising that fits in said slot on said casing as described in claim 5. Also, said cavity includes two vertical straight edges made of a conductive metal, one on each side exposed within said cavity, and of a certain dimension and, position that when fitted with said power bank device, they fit between said grooves of said power bank device and contact with said strip of metals as described in claim 5.

7. In claim 1 wherein said circuit board can process, store, and transmit data regarding the volume and frequency of electrical pulse received from said piezoelectric device, it also regulates and sends current to the battery.

8. In claim 1 wherein said app receive data from said circuit board and process it along with information entered via app such as weight, height along and GPS location, to produce and display useful information, such as speed, distance, time, calories lost, battery status etc.

9. A type of shock absorbent and energy return shoes with the heel portion of each shoe divided into an upper and lower portion; causing a horizontal gap between both said portions, and having at least one resistive device connected to said lower portion and said upper portion or the upper of said shoe.
A means to block off said gap to prevent objects from entering between said upper and lower portion.
A means to generate electrical pulses, preferably using the movement of the resistive device.
A power bank device, preferably small, and for use of storing said generated electricity.
A means to carry said power bank on said shoe.
Wherein said resistive device and lower portion is one structure, with a portion or portions extending upwards and attached to the side of the midsole and/or upper, such that there is a gap between the bottom of said structure and said midsole, and whereby said extension(s) performs the actual resistive and energy return functions by folding to the side or outwards while absorbing impact.

10. A type of shock absorbent and energy return shoes with the heel portion of each shoe divided into an upper and lower portion; causing a gap between them.
At least one resistive device, preferably having the following characteristics; elongated, capable of storing energy along its entire length, and having a curved shape or connected to said lower and upper portions such that it bends or folds outwards or to the side.
A means to generate electricity from the movement of said resistive device.
A means to direct said electricity to an electrical component preferably a power bank charger device.
Whereby said resistive device stores and releases energy as said shoes impact and leaves the ground; causing said gap close and reopen to various degrees depending on the force of said impact.
